(19) United States
(12) Patent Application Publication
(10) Pub. No.: US 2005/0244046 A1
(43) Pub. Date: Nov. 3, 2005

(54) Sheet media identification method and sheet media identification apparatus

(75) Inventor: Ichiro Yamamoto, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignees: FUJITSU LIMITED, Kawasaki (JP); FUJITSU FRONTECH LIMITED, Tokyo (JP)

(21) Appl. No.: 11/171,376

(22) Filed: Jul. 1, 2005

Related U.S. Application Data
(63) Continuation of application No. PCT/JP03/03104, filed on Mar. 14, 2003.

(51) Int. Cl. G06K 9/00; G06K 9/68

(52) U.S. Cl. 382/135; 382/218

(57) ABSTRACT

A sheet media identification method works out the primary differentiation of the density of each pixel of a transmission image of a bill (FIG. 5, S21), followed by simply binarizing the differentiation result by comparing it with a predetermined threshold value to extract the contour lines of the bill. A Hough-transform is then applied to the binarized contour lines to extract the contour lines passing through the same point on a Hough-plane as the disconnected elements of a single line, followed by extracting a rectangle surrounded by the straight lines corresponding to the points obtained by the Hough-transform. If the number of dots in the non-overlapping part of the rectangle is not less than a predetermined threshold value, cuts out the non-overlapping part as the image of the bill, followed by comparing the cut-out image with a reference image to define the type of the bill.

### CROSS-REFERENCE TO RELATED APPLICATIONS

This application is a continuation of International Application No. PCT/JP2003/003104, which was filed on Mar. 14, 2003.

### BACKGROUND OF THE INVENTION

1. Field of the Invention

The present invention relates to an identification method for identifying a sheet media such as a bill and the identification apparatus.

2. Description of the Related Art

When multi-sheet feeding bills or a folded bill, et cetera, are detected during a deposit or payout nd operation of a deposit machine or an automatic teller machine (“ATM” hereinafter) used in institutions such as banks, such bills are stored in a reject box instead of being differentiation processed.

It is, however, impossible to determine the type or number of such bills stored in the reject box unless a qualified person removes the bills from the box and counts or examines such bills.

For instance, a method is noted in a Japanese unexamined patent application publication No. 10-302112 (“patent document 1” hereinafter), for decreasing the number of rejected bills by reusing the rejected bills. Bills are processed by a bill differentiation unit through a re-differentiation process in which the rejected bills are returned to a bill input unit, which feeds them through at a slower speed.

A second patent, Japanese registered patent No. 3320386 (“patent document 2” hereinafter), notes a method which tracks the type and number of bills being transported, thereby making it possible to determine the type and number of bills even when multi-sheet feeding occurs.

The method noted in patent document 1, however, merely undertakes to improve the accuracy of differentiation by decreasing the transport speed and does not differentiate bills of multiple sheet feeding.

The method noted in patent document 2, merely tries to estimate the type and number of bills by the thickness of the bills and tracking which bill box the bill is fed out of.

[Patent document 1] Japanese unexamined patent application publication No. 10-302112, FIG. 1; paragraph 0008

[Patent document 2] Japanese registered patent No. 3320386, FIG. 6; paragraphs 0035 and 0036

### SUMMARY OF THE INVENTION

The challenge of the invention is to make it possible to identify the type of media despite overlapping.

A sheet media identification method according to the present invention comprising; detecting a transmission image of a medium constituted of sheet media; storing a detected image in a storage unit; extracting contour lines of an image stored in the storage unit; extracting an area based on the extracted contour lines; cutting a transmission image, or an overlapping part or a non-overlapping part of a reflective image, out of an extracted area; and identifying the type of medium by comparing a cut-out image with a reference image.

According to the present invention, it is possible to identify the type of an overlapping medium by comparing an image of a non-overlapping part or an overlapping part, cut out of an image overlapping a reference image.

Another sheet media identification method according to the present invention comprising; detecting a transmission image of a medium; storing a detected image in a storage unit; extracting contour lines of an image stored in the storage unit; extracting an area based on the extracted contour lines; calculating the pixel density of the extracted area; judging whether or not images of a plurality of overlapping areas are images of one medium depending on whether or not the calculated pixels density is equal to, or greater than, a predetermined value; cutting out a transmission image, or an overlapping part or a non-overlapping part of a reflective image, based on the size of the overlapping part or the non-overlapping part of an image; and identifying the type of medium by comparing a cut-out image with a reference image.

According to the present invention, it is possible to identify the type of overlapping medium by comparing an image of a non-overlapping part or an overlapping part cut-out of an image of an overlapping medium with a reference image. It is also possible to identify either an image of the same medium or different media by calculating the image density.

In the above described sheet media identification method, wherein the same straight lines are extracted from extracted contour lines by applying Hough-transform and a rectangle surrounded by extracted straight lines is extracted.

Application of the Hough-transform makes it possible to simply extract a single straight line from a plurality of contour lines extracted from an image of a medium, hence the contour of the medium accurately.

In the above described sheet media identification method, wherein whether or not a non-overlapping part of an image is less than a predetermined size is judged and, if the aforementioned part is less than the predetermined size, an overlapping part is cut-out; otherwise the non-overlapping part is cut-out.

Such a configuration makes it possible to cut an appropriate image from an overlapping medium for collation.

In the above described sheet media identification method, wherein intersections of diagonal lines of a plurality of rectangular areas having overlapping parts are respectively calculated, rectangles whose respective coordinates of intersections of diagonal lines are within a predefined range are grouped together as one, and an image for collation is cut-out of one image for each group.

Such a configuration makes it possible to extract one area from a medium by grouping together extracted areas into one even if a plurality of areas are extracted from the medium. Note that the possibility of grouping together two nearly perfectly overlapping sheets of a medium into one is countered by measuring the transmission density thereof and thereby judging the images to be images of different media.

In the above described sheet media identification method, wherein Niblack binarization is applied to a cut-out image and the type of bill is identified by comparing the binarized image with a Niblack-binarized reference image.

Such collation, using Niblack binarization, enables collation processing to be shortened while improving the accuracy of the collation.

FIG. 1 describes the principle of a sheet media identification apparatus according to the present invention.

A sheet media identification apparatus according to the present invention comprises an image detector unit 1 for detecting the transmission image of media constituted of sheet medias, et cetera, a storage unit 2 for storing the detected image, a contour line extraction unit 3 for extracting contour lines of an image stored in the storage unit 2, an area extraction unit 4 for extracting an area based on the extracted contour lines, a cut-out unit 5 for cutting either a transmission image, or an overlapping part or non-overlapping part of a reflective image, out of an extracted area, and an identification unit 6 for identifying the type of medium by comparing a cut-out image with a reference image.

It is possible to identify the type of medium despite overlapping by comparing an image of a non-overlapping or overlapping part of an overlapping image with a reference image according to the present invention.

Another sheet media identification apparatus according to the present invention comprises an image detector unit 1 for detecting a transmission image of medium constituted of sheet media, et cetera, a storage unit 2 for storing the detected image, a contour line extraction unit 3 for extracting contour lines of an image stored in the storage unit 2, an area extraction unit 4 for extracting an area based on the extracted contour lines, a density calculation unit 7 for calculating the pixel density of the extracted area, a judgment unit 8 for judging whether or not images in a plurality of areas with overlapping parts are images of one medium, depending on whether or not a calculated pixel density is equal to, or greater than, a predetermined value, a cut-out unit 5 for cutting out either an overlapping part or non-overlapping part of an image based on the size of the overlapping or non-overlapping part, and an identification unit 6 for identifying the type of medium by comparing the cut-out image with a reference image.

It is possible to identify the type of overlapping medium by comparing an image of a non-overlapping or overlapping part cut out of an overlapping image with a reference image according to the present invention. It is also possible to judge whether an image is of one medium or different media by calculating the pixel density of the image.

In the above noted invention, the image pickup unit picks up a transmission image or a reflective image of the medium, and the cut-out unit cuts out an image of an overlapping or non-overlapping part of the reflective image by defining the overlapping part of the reflective image corresponding to the overlapping part of the transmission image.

Such a configuration makes it possible to determine an overlapping part of the transmission image and the overlapping part of the reflective image corresponding to the overlapping part of the transmission image, and thus to cut-out an appropriate image from the reflection image of an overlapping medium for collation.

### BRIEF DESCRIPTION OF THE DRAWINGS

FIG. 1 shows the principle of the present invention;

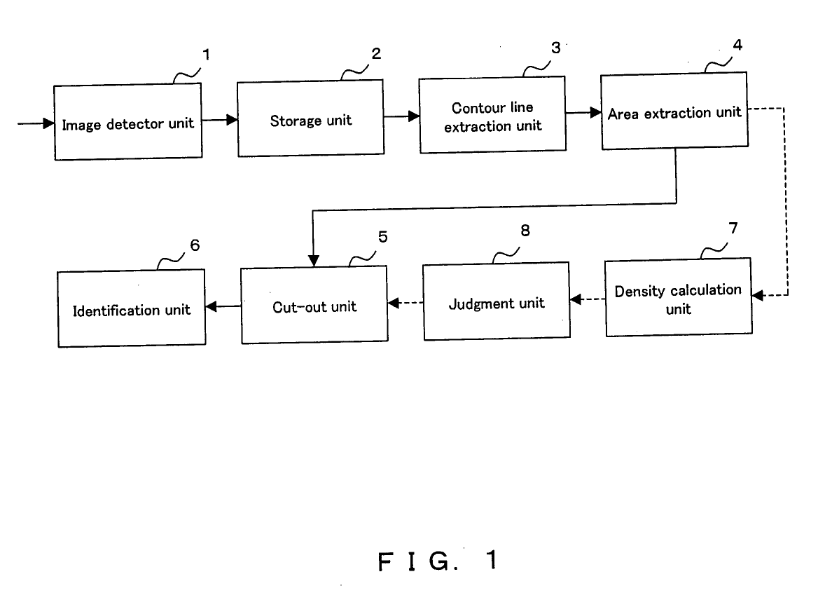

FIG. 2 shows a configuration of the transport system and bill storage unit of an ATM according to an embodiment;

FIG. 3 shows a configuration of the control unit;

FIG. 4 shows a flow chart of bill identification processing;

FIG. 5 shows a flow chart of media cut-out processing;

FIG. 6 shows a flow chart of Niblack binarization processing;

FIG. 7 shows densities and threshold values of an image;

FIG. 8 shows a flow chart of matrix collation processing;

FIGS. 9(A), (B) and (C) show a reflective image, a transmission image, and the contour of an extracted image, respectively;

FIGS. 10(A) and (B) show rectangles drawn based on the extracted contours;

FIGS. 11(A) and (B) show reflection images corresponding to the drawn rectangles;

FIGS. 12(A) and (B) show images where overlapping parts have been deleted;

FIGS. 13(A) and (B) show extracted rectangles that have been rotated, and translated to the origin; (C) and (D) show binarized images; and

FIG. 14 shows binarized images of registered bills.

### DESCRIPTION OF THE PREFERRED EMBODIMENTS

An embodiment of the present invention will be described while referring to the accompanying drawings in the following.

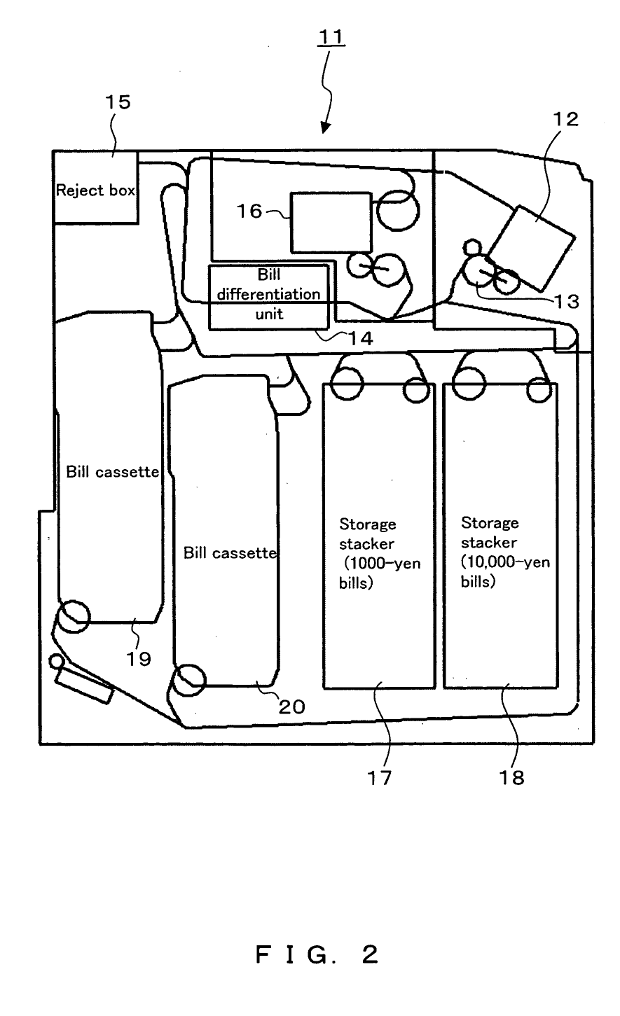

FIG. 2 shows configurations of the transport system and bill storage unit of an ATM 11 according to the present embodiment. A sheet media identification apparatus according to the present invention can be accomplished as an apparatus equipped in an ATM, et cetera, or as a bill differentiation machine. Note that the word “sheet media” is comprehensive and includes paper media such as bills, bank checks, indentures, et cetera.

A bill deposited in a deposit and payout unit 12 is fed to an internal transport path by feed out rollers 13, and is subjected to inspection for multiple feeding, and identification of the type of bill, and differentiation of legitimate and counterfeit bills in a bill differentiation unit 14. Bills judged to be rejected are stored in a reject box 15.

A bill judged as legitimate currency fed normally (i.e., without multiple feeding) is stacked in a temporary stack unit 16 at the bill differentiation unit 14. A bill stacked in the temporary stack unit 16 is fed through the bill differentiation unit 14 a second time after the customer finishes a confirmation operation for the deposit amount, and fed to a storage stacker 17 for one-thousand yen bills or a storage stacker 18 for ten-thousand yen bills, as appropriate. If the customer performs a deposit cancellation operation after putting money into the machine, the bills stacked in the temporary stack unit 16 are fed out to the deposit and payout unit 12.

If a customer performs a payout operation, bills stacked in bill cassettes 19 and 20 are fed out through the transport path to the deposit and payout unit 12.

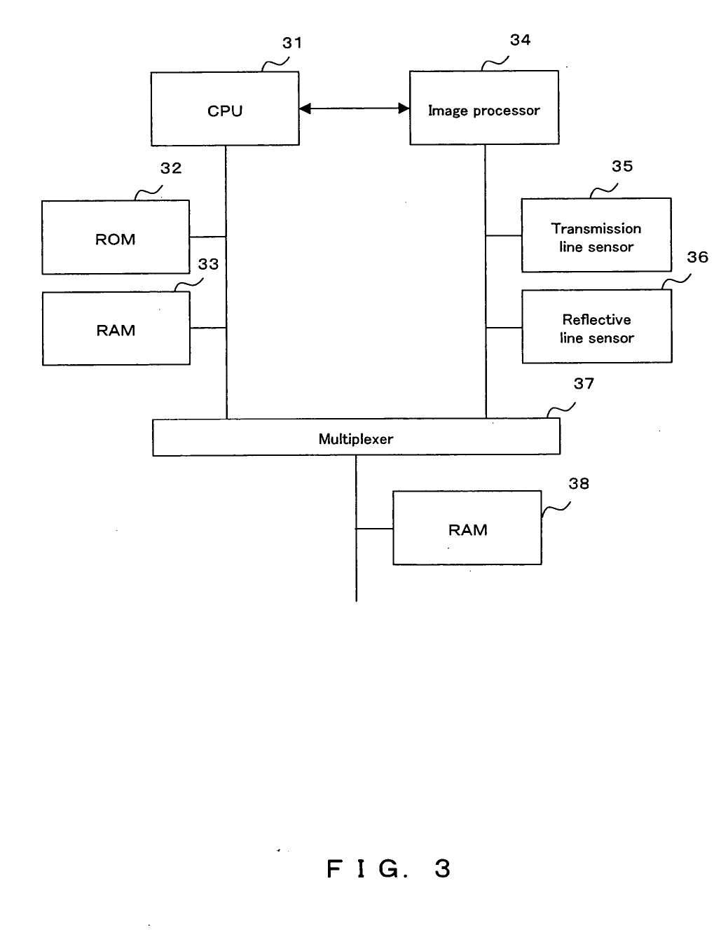

FIG. 3 shows the configuration of the control unit for controlling bill transport, identifying the type of rejected bill and differentiating legitimate and counterfeit bills in the bill differentiation unit 14.

A CPU 31 executes the transport control, identification of the type of rejected bill and differentiation of legitimate and counterfeit bills according to a program stored in ROM 32; instructs an image processor 34 to perform extraction of contour lines, collation of images, et cetera; and stores the processing result data in RAM 33.

The image processor 34 performs contour extraction processing, area extraction processing, et cetera, of image data of a bills imaged by a transmission line sensor 35 and a reflective line sensor 36 respectively which are equipped in the bill differentiation unit 14, and stores the resultant image data in RAM 38 by way of a multiplexer 37. The image data stored in the RAM 38 can be read by the CPU 31 by way of the multiplexer 37.

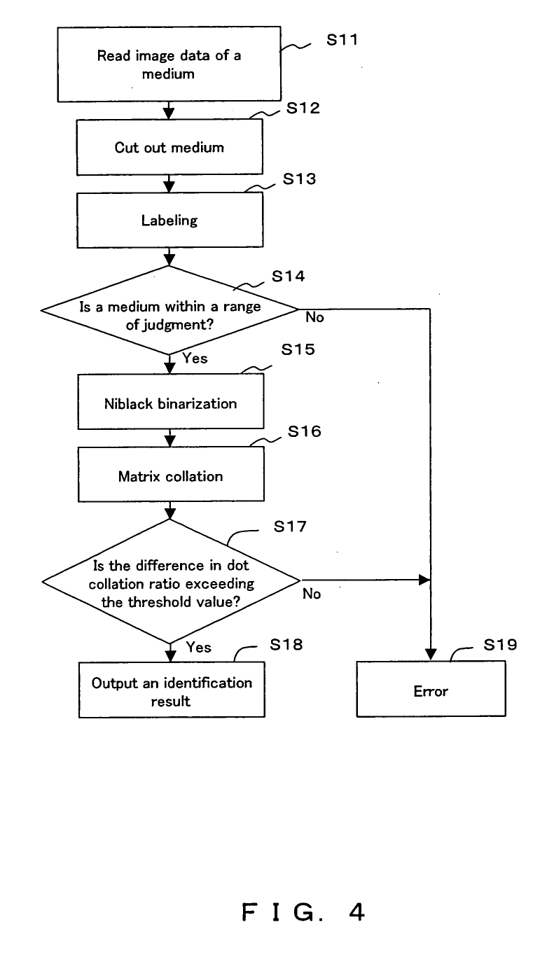

FIG. 4 shows a flow chart of the process flow of the bill differentiation unit 14. The CPU 31 and the image processor 34 execute the following processes.

First, the transmission line sensor 35 and the reflective line sensor 36 detect image data of a bill, and store the detected image data in the RAM 38 (FIG. 4, S11).

Then, the process executes cut-out processing of the medium (FIG. 4, S12). The medium cut-out processing performs contour and rectangle extraction on an image for cutting out of an overlapped medium.

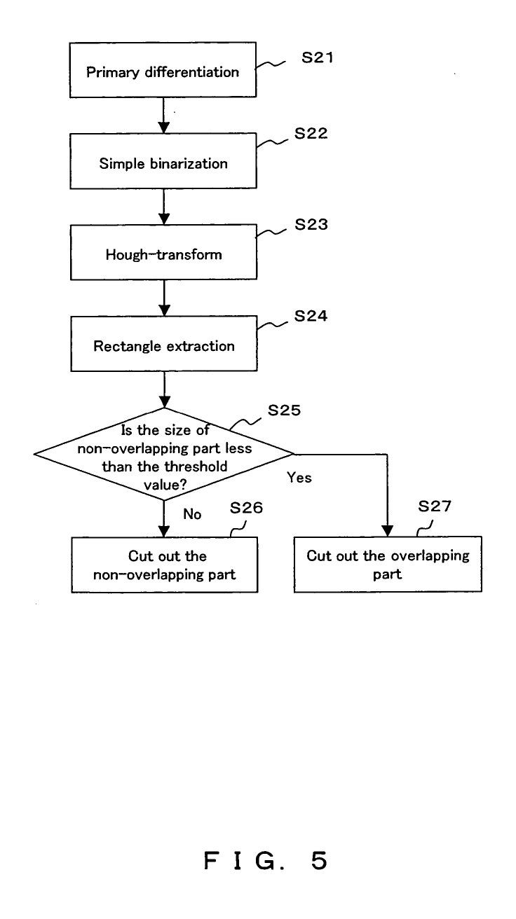

FIG. 5 shows a flow chart of media cut-out processing of step S12 shown in FIG. 4, which calculates the primary differentiation of the density of each pixel in a transmission image of a bill detected by the transmission line sensor 35 (FIG. 5, S21).

The result of the differentiation is simply binarized by comparing it with a predetermined threshold value for extracting the contour lines of the bill (FIG. 5, S22). The transmission line sensor 35 detects the transmission image of a bill, by reading the bill and setting the background white in the present embodiment. This maximizes the density difference between the border and the background, e.g., along the contour lines of a bill, hence enabling the contour lines to be extracted by connecting points at which the maximum density slope occurs.

A Hough-transform is applied to the binarized contour lines and which extracts the contour lines passing through the same point on the Hough-plane as the same straight line (FIG. 5, S23). A Hough-transform transforms a straight line to a point expressed by the distance ρ from the datum point and the angle θ, and therefore an arbitrary straight line can be expressed by the point (ρ,θ) on a Hough-plane defined by the angle θ on the X-axis and the distance ρ on the Y-axis.

Rectangle extraction processing is executed in step S24, which groups the lines corresponding to points gained by the Hough-transformation into two groups, i.e., the vertical and horizontal lines, and constructs a rectangle surrounded by the respectively grouped vertical and horizontal lines in the X-Y axis.

Detection error caused by the transmission line sensor 35 or the ragged edge of a bill may cause extraction of a plurality of contour lines for one bill which may in turn lead to the construction of a plurality of rectangles for one medium (i.e., a bill). In such a case, those rectangles are grouped by the coordinates of the diagonal lines for each respective rectangle, and a plurality of rectangles whose coordinates are within a predefined area are represented by one rectangle. The average pixel density is calculated at the overlapping part of the rectangles and it is judged whether or not the average density is higher than a predetermined threshold value. Note that the gray scale image data is defined so that the density of white is the highest with densities gradually lowering toward black in the present embodiment.

If the average pixel density is lower than the threshold value, that is, the density thereof is close to black, it is judged that image is of a plurality of overlapped media and accordingly these images are treated as those of different media. If the average pixel density is the same as the threshold value or greater, the judgment is that the image is of one medium and subsequent processes treats it as an image of the same group accordingly.

When the extraction of the rectangles is completed, and if there is an overlapping part, the number of pixels (i.e., dots) for not-overlapped parts (“non-overlapping part” hereinafter) is counted and it is judged whether or not the number of pixels for the non-overlapping part is less than a predetermined threshold value (FIG. 5, S25).

If the number of pixels for the nonoverlapping part of the rectangle is not less than the predetermined threshold value (“No” in S25), that is, the number of pixels for the non-overlapping part is the same as, or greater than, the threshold value, the process proceeds to step S26 and cuts the non-overlapping part out as an image of the medium.

Conversely, if the number of pixels for the non-overlapping part is less than the threshold value, (“Yes” in S25), processing proceeds to step S27 and cuts the overlapping part out as an image of the medium.

By the above described processes of steps S21 through S27, it is possible to extract the contour of a medium and a rectangle (i.e., area) from the contour, and then cut out an image of a non-overlapping or overlapping part of the bill as an object for identification.

With completion of the cutting out of the medium, the labeling processing of step S13 is executed as shown by FIG. 4, and a number is assigned to the cut-out medium.

Then, the process determines whether or not it is a bill within the range of judgment by examining whether or not the length of the medium is within the range of the length of the long side of the predefined bills.

If the length of the long side of the medium is within a specified range of the bill (“Yes” in S14), processing proceeds to step S15 and executes Niblack binarization processing, (Refer to W. Niblack: “An Introduction to Digital Image Processing”) which is applied to an image cut out of a reflective image detected by the reflective line sensor 36.

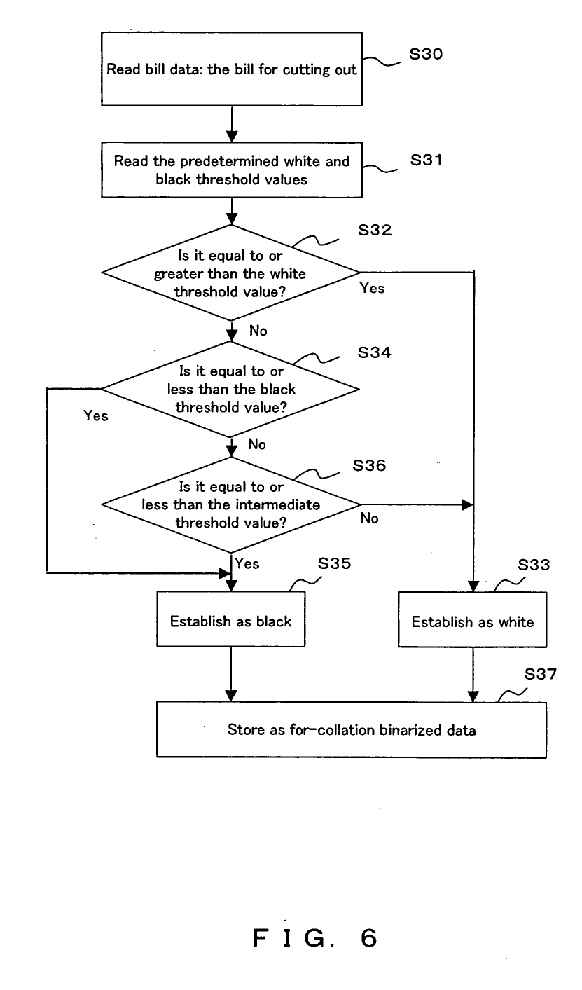

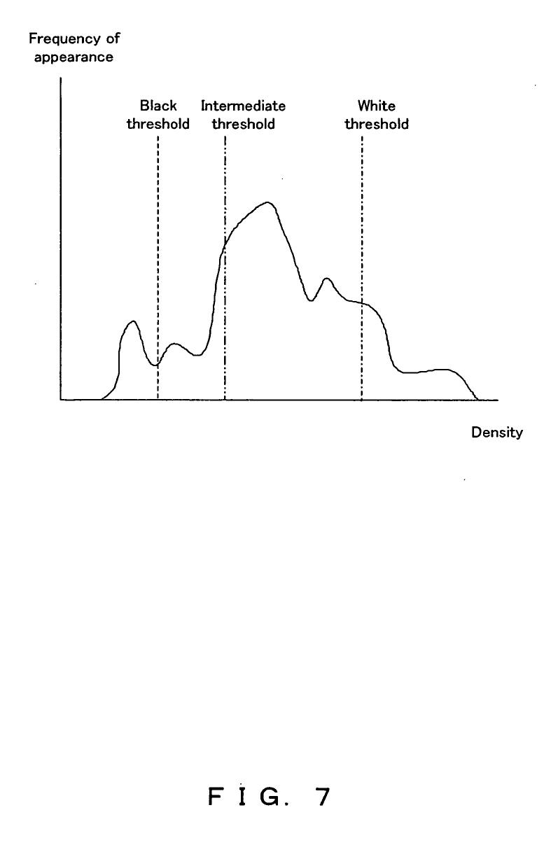

FIG. 6 shows a flow chart of Niblack binarization process; and FIG. 7 shows a white, intermediate and black threshold values for the Niblack binarization process and a distribution of pixel densities.

Niblack binarization defines a while threshold value (i.e., the threshold value for high densities), a black threshold value (i.e., the threshold value for low densities) and in addition an intermediate threshold value as shown by FIG. 7. Binarizing densities of pixels to determine which pixels are white and which pixels are black is based on the white and black threshold values, respectively. An improvement in the accuracy of identifying the type of bills by using a later described pattern matching through Niblack binarization has been confirmed.

In the process shown by FIG. 6, first reads out of RAM 38, the image data of the reflective image of the bill (i.e., bill data) corresponding to the area (i.e., non-overlapping or overlapping part) cut-out of the transmission image in the above described medium cut-out processing (FIG. 6, S30).

Then, reads the predetermined white and black threshold values (FIG. 6, S31).

Then, judges whether or not the density of the pixel of a cut-out medium is equal to, or greater than, the white threshold value (FIG. 6, S32). If the pixel density is equal to or greater than the white threshold value (“Yes” in S32), the process proceeds to step S33 and establishes the pixel to be white.

If the pixel density is less than the white threshold value (“No” in S32), the process proceeds to step S34 and judges whether or not the pixel density is equal to, or less than, the black threshold value.

If the pixel density is equal to, or less than, the black threshold value (“Yes” in S34), the process proceeds to step S35 and establishes the pixel to be black.

If the pixel density is judged to be greater than the black density (“No” in S34), the process proceeds to step S36 and judges whether or not the pixel density is equal to, or less than, the intermediate threshold value.

If the pixel density is equal to or less than the intermediate threshold value (“Yes” in S36), the process proceeds to the above noted step S35 and establishes the pixel to be black. Meanwhile, if the pixel density is greater than the intermediate threshold value (“No” in S36), the process proceeds to step S33 and establishes the pixel to be white.

Once a determination of the pixel value has been made by step S33 or S35, the established pixel value is stored in the RAM 38 as binarized data for collation (FIG. 6, S37).

It is possible to binarize an image detected from a bill by applying the above described Niblack binarization to each pixel of a cut-out image of a reflective image (i.e., image corresponding to a cut-out part of a transmission image).

After completing Niblack binarization processing as in the step S15 shown by FIG. 4, the process executes matrix collation (“pattern matching” hereinafter) processing in the step S16 shown by FIG. 4.

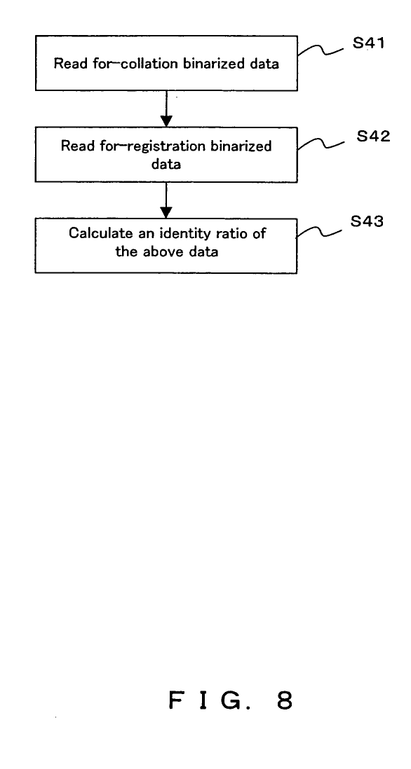

FIG. 8 shows a detailed flow chart of matrix collation processing in the above noted step S16.

First, binarized data of a reflective image is read from RAM 38 (FIG. 8, S41), as the object of pattern matching (“for-collation binarized data” hereinafter).

Then, binarized data for each type of bill is read from nonvolatile memory such as the ROM 32 (FIG. 8, S42), as a reference for the pattern matching (“for-registration binarized data” hereinafter).

The last step calculates an identity ratio (“dot collation ratio” hereinafter), of the for-collation binarized data being detected from a bill to the for-registration binarized data of the reference, which is stored in the ROM 32 (FIG. 8, S43).

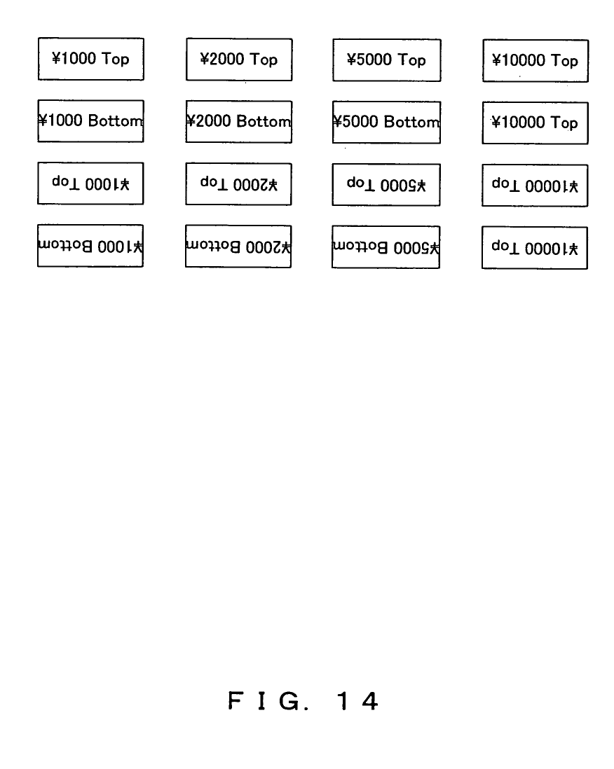

Then determines the type of bill indicating a high collation ratio by reading the binarized images and calculating the dot collation ratios, as described in the above steps S41 through S43, in relation to the basic images of the top and bottom faces as well as that of the inverted bills for every type of bill which is stored in the ROM 32. Note that the Niblack binarization data of the top and bottom faces as well as that of the inverted bills for every type of bill is stored in the ROM 32 as shown by FIG. 14.

When finishing the matrix collation, the process proceeds to step S17 shown by FIG. 4 and judges whether or not the difference between the dot collation ratio for the type of bill with the highest collation ratio and that for the type of bill with the second highest collation ratio is equal to, or greater than, a predetermined threshold value.

If the difference in the dot collation ratios is equal to or greater than the threshold value (“Yes” in S17), the collation ratio for a specific type of bill is substantially different from that of the other types of bills, the process proceeds to step S18, determines the type of bill as the object and outputs the result as the identification result.

Conversely, if there is a smaller difference between the dot collation ratio of the highest and that of the second highest than the threshold value (“No” in S17), there is no substantial difference in the collation result and it is not possible to determine the type of bill and processing proceeds to step S19 and executes error processing.

It is possible to identify a type of bill that is overlapped such as might occur due to multiple-sheet feeding, folding, et cetera, according to the above described embodiment. Storing the type and number of identified bills in the RAM 33 makes it possible for a remotely located control center, et cetera, to comprehend the types and number of bills stored in the reject box without a qualified person retrieving the reject box of the ATM.

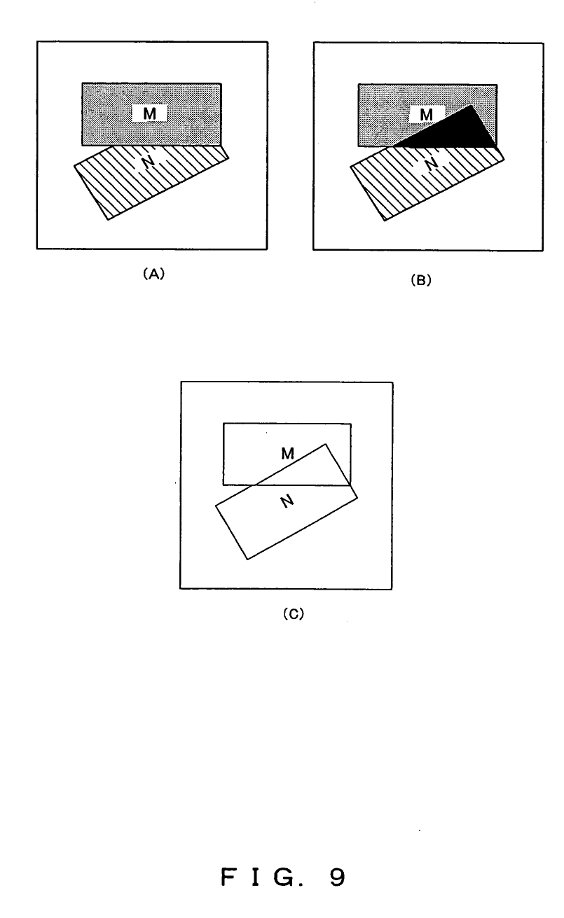

Next, an identification method for the type of bill by the above described extraction of contour lines and rectangle, and Niblack binarization will be specifically described while referring to the images shown by FIGS. 9 through 14.

FIGS. 9(A) and (B) exemplify a reflective image and a transmission image detected respectively by the reflective line sensor 36 and the transmission line sensor 35 comprised by the bill differentiation unit 14; and FIG. 9(C) shows contour lines extracted from the transmission image. Note that while FIG. 9(C) shows the straight contour lines, instead of jagged lines, a plurality of contour lines may actually be extracted from one medium.

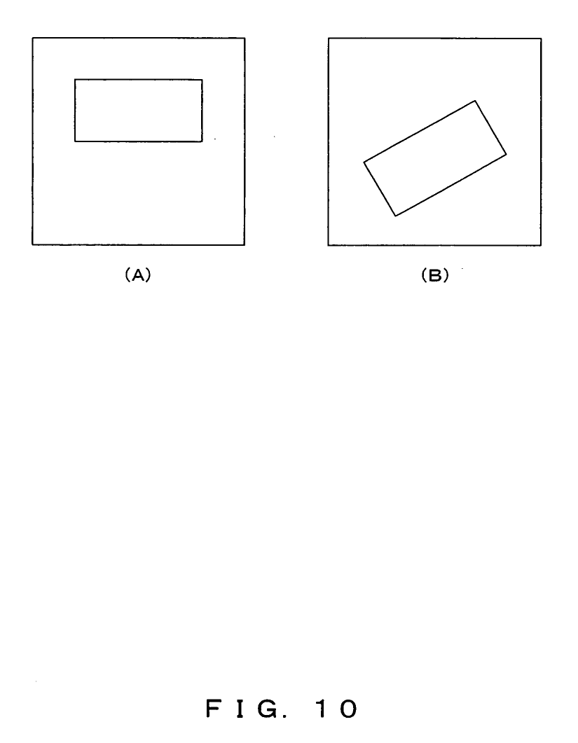

A Hough-transform is applied to the extracted contour lines and combines the obtained lines to extract rectangles as shown by FIGS. 10(A) and (B). Furthermore, it is judged whether or not the size of non-overlapping parts (i.e., the number of dots) of the extracted rectangle is equal to, or greater than, a predetermined value, and, if it is equal to or greater than the predetermined value, cuts out the non-overlapping part; whereas if it is less than the predetermined value, it cuts out the overlapping part.

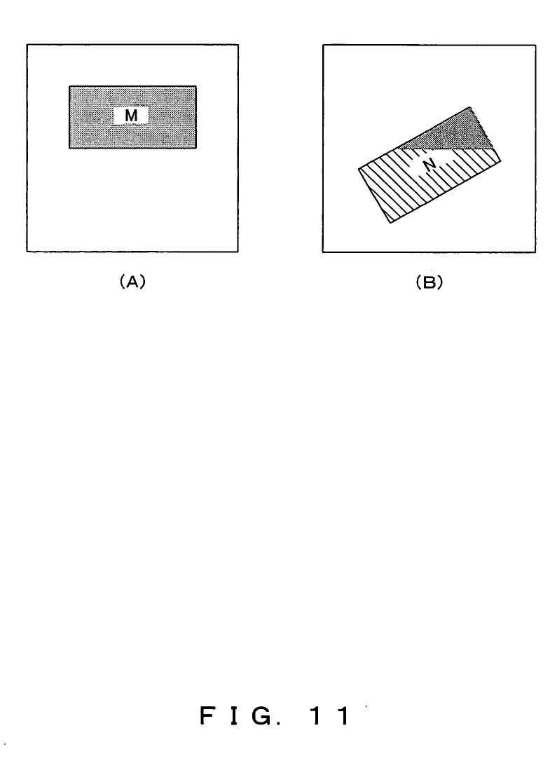

The coordinates of straight lines of the extracted rectangle are calculated, and the area surrounded by the corresponding coordinates of the reflective image and the area of the overlapping part determined, as shown by FIG. 11. The image data of these parts is read from the RAM 38.

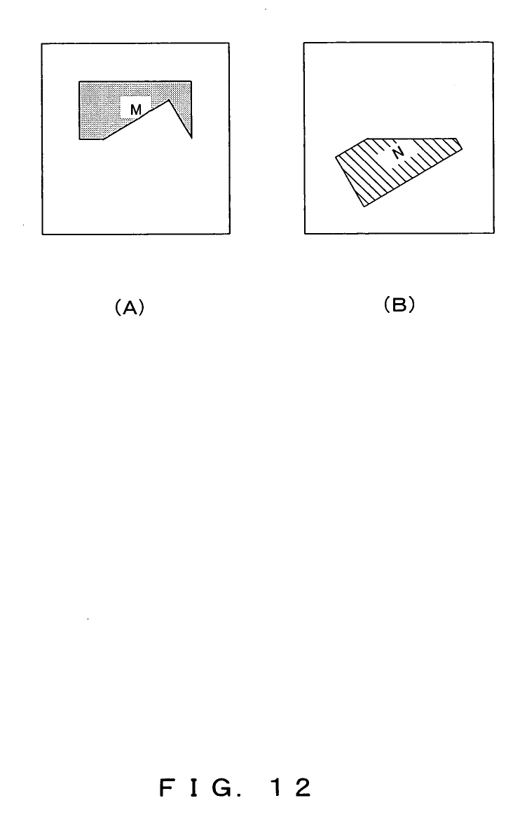

Overlapping parts from the read-out image are deleted. FIGS. 12(A) and (B) show images (i.e., gradation data) after the overlapping parts have been deleted from the reflective image.

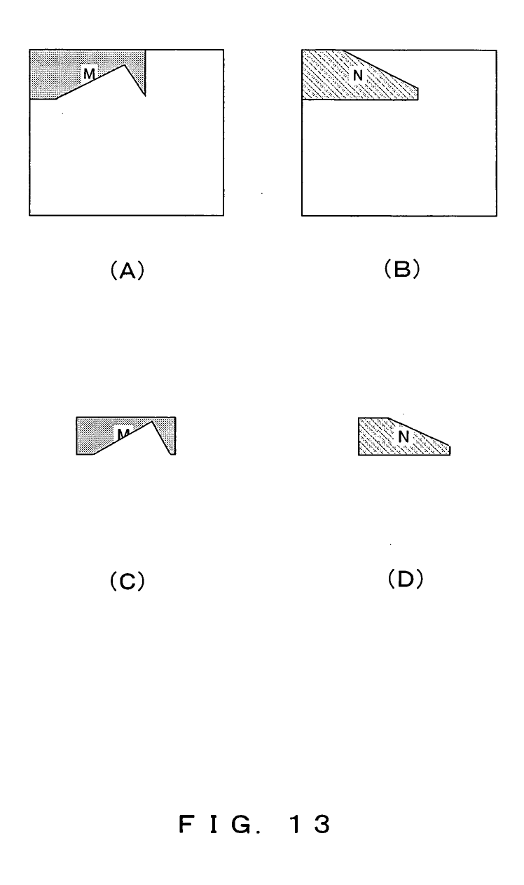

Then, the process moves the images to the respective positions as shown in FIGS. 13(A) and (B) by rotating and translating the images so that the points at the top-left corner of the respective images correspond with the origin of the X-Y coordinate system, followed by binarizing the moved images by Niblack binarization. FIGS. 13(C) and (D) show binarized images after the overlapping parts having been deleted.

Once the binarized image has been obtained, after the deletion of the overlapping part, the for-registration binarized data stored in the ROM 32 is read, which stores the Niblack binarization data of four kinds of images, i.e., top face, bottom face, the inverted top face and the inverted bottom face, for each type of bill as shown by FIG. 14.

Subsequently, the process moves the images that have had the overlapping part deleted to the respective origins of the X-Y coordinate systems as shown by FIGS. 13(A) and (B), compares the Niblack binarization images of the aforementioned images with the registered binarized image data for each type of bill and selects the type of bill indicating the highest degree of similarity. It is then judged whether or not the difference in the degree of similarity between the highest degree of similarity for a certain type of bill and the second highest degree thereof for another type is equal to, or greater than, a predetermined threshold value, and, if the difference in the degree of similarity is equal to or greater than the predetermined threshold value, determined that the type of bill is in fact the read-out type of bill. Note that a comparison may be constrained by for instance masking for-registration binarized data corresponding to the image data for the deleted part, or for-registration data corresponding to the cut-out part only may be read out, in comparing the images.

The present invention is not limited by the above described embodiment, but it may be configured as follows:
(a) while the present embodiment cuts out an overlapping part by a transmissive image and compares the reflective image corresponding to the cut-out part with a reference image, it is possible to compare an image cut out of a transmission image with a reference image; and/or
(b) the present invention may be applied to not only a bill identification apparatus, but also any apparatuses required to identify paper media, such as bank checks, certificates or indentures, et cetera, despite overlapping.

It is possible to identify the type of paper sheet despite overlapping according to the present invention. For instance, it is possible to determine the type and number of rejected bills in an ATM, et cetera, and therefore it is possible to comprehend the types and number of rejected bills at a remotely located control center, without ever visiting the ATM installation to confirm the bills stored in the reject box.

1. A sheet media identification method, comprising:
storing a detected image in a storage unit by detecting a transmission image of a medium constituted of sheet media;
extracting contour lines of an image stored in the storage unit;
extracting an area based on extracted contour lines;
cutting a transmission image, or an overlapping part or a non-overlapping part of a reflective image, out of an extracted area; and
identifying a type of medium by comparing a cut-out image with a reference image.

2. The sheet media identification method according to claim 1, wherein
the same straight lines are extracted from extracted contour lines by applying a Hough-transform and a rectangle surrounded by extracted straight lines is extracted.

3. The sheet media identification method according to claim 1, wherein
whether or not a non-overlapping part of image is less than a predetermined size is judged and, if the aforementioned part is less than the predetermined size, an overlapping part is cut out, otherwise a non-overlapping part is cut out.

4. The sheet media identification method according to claim 1, wherein
intersections of diagonal lines of a plurality of rectangular areas having overlapping parts are respectively calculated, rectangles whose respective coordinates of intersections of diagonal lines are within a predefined range are grouped together as one, and the type of bill is identified by comparing one image for each group with a reference image of a bill.

5. The sheet media identification method according to claim 1, wherein
Niblack binarization is applied to a cut-out image, and a kind of bill is identified by comparing the binarized image with a Niblack binarized reference image.

6. A sheet media identification method, comprising:
storing a detected image in a storage unit by detecting a transmission image of a medium constituted of sheet media;
extracting contour lines of an image stored in the storage unit;
extracting an area based on extracted contour lines;
calculating the pixel density of an extracted area;
judging whether or not images of a plurality of overlapping areas are images of one medium based on a calculated pixel density;
cutting out a transmission image, or an overlapping part or a non-overlapping part of a reflective image, based on the size of image in the overlapping part or the non-overlapping part; and
identifying the type of medium by comparing a cut-out image with a reference image.

7. The sheet media identification method according to claim 6, wherein
the same straight lines are extracted from extracted contour lines by applying a Hough-transform and a rectangle surrounded by extracted straight lines is extracted.

8. The sheet media identification method according to claim 7, wherein
whether or not a non-overlapping part of image is less than a predetermined size is judged and, if the aforementioned part is less than the predetermined size, an overlapping part is cut out, otherwise a non-overlapping part is cut out.

9. The sheet media identification method according to claim 7, wherein
intersections of diagonal lines of a plurality of rectangular areas having overlapping parts are respectively calculated, rectangles whose respective coordinates of intersections of diagonal lines are within a predefined range are grouped together as one, and the type of bill is identified by comparing one image for each group with a reference image of a bill.

10. The sheet media identification method according to claim 7, wherein
Niblack binarization is applied to a cut-out image, and a kind of bill is identified by comparing the binarized image with a Niblack binarized reference image.

11. A sheet media identification apparatus, comprising:
an image detector unit detecting a transmission image of a medium constituted of sheet media;
a storage unit storing a detected image;
a contour extraction unit extracting contour lines of an image stored in the storage unit;
an area extraction unit extracting an area based on extracted contour lines;
a cut-out unit cutting a transmission image, or an overlapping part or a non-overlapping part of a reflective image, out of an extracted area; and
an identification unit identifying a kind of medium by comparing a cut-out image by the cut-out unit with a reference image.

12. The sheet media identification apparatus according to claim 11, wherein
said contour extraction unit extracts same straight lines by applying a Hough-transform; and
said area extraction unit extracts a rectangular area surrounded by the straight lines.

13. The sheet media identification apparatus according to claim 11, wherein
said cut-out unit judges whether or not an area size of a non-overlapping part of an image is less than a predetermined value and, if the size of the non-overlapping part is less than the predetermined value, an overlapping part is cut out, otherwise the nonoverlapping part is cut out.

14. The sheet media identification apparatus according to claim 11, wherein
said detector unit picks up a transmission and reflective images of the medium, and
said cut-out unit determines an overlapping part of the reflective image corresponding to an overlapping part of the transmission image, and cuts out an image of overlapping or non-overlapping parts of the reflective image.

15. A sheet media identification apparatus, comprising:
an image detector unit detecting a transmission image of a medium made of sheet media;
a storage unit storing a picked up image by the image pickup unit;
a contour extraction unit extracting contour lines of an image stored in the storage unit;
an area extraction unit extracting an area based on extracted contour lines;
a density calculation unit calculating the pixel density of an extracted area;
a judgment unit judging whether or not images of a plurality of overlapping areas are images of one medium depending on whether or not a calculated pixel density is equal to, or greater than, a predetermined value;
a cut-out unit cutting a transmission image, or an overlapping part or a non-overlapping part of a reflective image, out of an extracted area; and
an identification unit identifying a kind of medium by comparing a cut-out image with a reference image.

16. The sheet media identification apparatus according to claim 15, wherein
said contour extraction unit extracts same straight lines by applying a Hough-transform; and
said area extraction unit extracts a rectangular area surrounded by the straight lines.

17. The sheet media identification apparatus according to claim 15, wherein
said cut-out unit judges whether or not an area size of a non-overlapping part of an image is less than a predetermined value and, if the size of the non-overlapping part is less than the predetermined value, an overlapping part is cut out, otherwise the non-overlapping part is cut out.

18. The sheet media identification apparatus according to claim 15, wherein
said detector unit picks up a transmission and reflective images of the medium, and
said cut-out unit determines an overlapping part of the reflective image corresponding to an overlapping part of the transmission image, and cuts out an image of overlapping or non-overlapping parts of the reflective image.
